(19) United States
(12) Patent Application Publication
(10) Pub. No.: US 2021/0239336 A1
(43) Pub. Date: Aug. 5, 2021

(54) SYSTEMS AND METHODS FOR FLUID-DYNAMIC ISOLATION OF ACTIVELY CONDITIONED AND RETURN AIR FLOW IN UNCONSTRAINED ENVIRONMENTS

(71) Applicant: Phononic, Inc., Durham, NC (US)

(72) Inventors: Jesse W. Edwards, Wake Forest, NC (US); Andrew J. Muto, Cary, NC (US); Devon Newman, Salt Lake City, UT (US); Austin J. Lewis, Durham, NC (US)

(21) Appl. No.: 17/167,738

(22) Filed: Feb. 4, 2021

Related U.S. Application Data
(60) Provisional application No. 62/970,011, filed on Feb. 4, 2020.

(51) Int. Cl. F24F 9/00

(52) U.S. Cl. CPC F24F 9/00; F24F 2009/002

(57) ABSTRACT

Systems and methods are disclosed herein for fluid-dynamic isolation of actively conditioned and return air flow in unconstrained environments. In some embodiments, a system for fluid-dynamic isolation of actively conditioned and return air flow in an unconstrained environment includes: a heat pump subsystem configured to create a conditioned air circuit; and an air curtain subsystem configured to create an air curtain air circuit that isolates the conditioned air circuit from an environment that is external to the system. In this way, conditioned air can be provided in spaces that were impractical before. In addition, this might be done in an efficient way.

### FIELD OF THE DISCLOSURE

The present disclosure relates to actively conditioning a space.

### BACKGROUND

Demand around the world is increasing for engineered micro-climates in open, outdoor spaces. Conventional HVAC solutions rely on walls and windows to contain the air and insulate the space. The absence of walls and windows outdoors means new solutions are required (see, e.g., FIGS. 1A-1D). The engineer or architect must employ several techniques to maintain thermal comfort in outdoor spaces both efficiently and cost effectively. Consider an energy balance of an occupant. Radiative and convective heat transfer dominate while the third mode of heat transfer, conduction, can be neglected. FIGS. 1A-1D illustrate examples of outdoor climate control applications.

Fans are typically used to increase convective cooling around the occupant by reducing the thickness of the hydrodynamic and thermal boundaries layers to increase heat and mass transfer at the surface of the occupant. Under mild conditions a fan is the most cost efficient. As the ambient temperature rises the occupant will begin to sweat which enhances mass transfer and evaporative cooling. As the temperature and/or humidity rise further the occupant feels increasing discomfort and an active cooling system is needed. The active cooling limit depends on several factors, for illustration purposes it has been arbitrarily defined at a dew point temperature of 21° C. on the psychometric chart, along with traditional human comfort zones for HVAC applications (see, e.g., FIG. 2). Active cooling using convectional HVAC equipment is bulky, and inefficient in an outdoor environment. FIGS. 2A and 2B illustrate a psychometric chart indicating an arbitrary limit of dew point temperature (21 Deg. C), above which active cooling is needed to provide comfort conditions and traditional methods with human comfort.

Radiative heat transfer is controlled by shading of the sun (for cooling) or the night sky (for heating) and applying low emissivity coatings to surfaces that have a large view factor (solid angle) with the occupant.

### SUMMARY

Systems and methods are disclosed herein for fluid-dynamic isolation of actively conditioned and return air flow in unconstrained environments. In some embodiments, a system for fluid-dynamic isolation of actively conditioned and return air flow in an unconstrained environment includes: a heat pump subsystem configured to create a conditioned air circuit; and an air curtain subsystem configured to create an air curtain air circuit that isolates the conditioned air circuit from an environment that is external to the system. In this way, conditioned air can be provided in spaces that were impractical before. In addition, this might be done in an efficient way.

In some embodiments, conditioned air flowing through the conditioned air circuit created by the heat pump subsystem is internally recirculated and protected from mixing with ambient air by the air curtain air circuit created by the air curtain subsystem.

In some embodiments, the system also includes an ambient air intake/discharge subsystem configured to reject air from the heat pump subsystem to the environment external to the system and/or to draw air from the environment into the heat pump subsystem to be conditioned.

In some embodiments, the system also includes a power/energy subsystem comprising one or more photovoltaic power or energy storage components for supplying power to the system.

In some embodiments, the heat pump subsystem comprises a thermoelectric cooler.

In some embodiments, the air curtain air circuit comprises a recirculation cell which is axis-symmetric about the axis of revolution.

In some embodiments, the air curtain air circuit comprises recirculation cell is symmetric about the mirror line of the system.

In some embodiments, one or more of the heat pump subsystem and the air curtain air circuit comprises at least one fan. In some embodiments, the at least one fan comprises an impeller and/or fans in specific directions.

In some embodiments, the heat pump subsystem comprises a hybrid system with an evaporative cooler and a thermoelectric cooler.

In some embodiments, a method of operating a system for fluid-dynamic isolation of actively conditioned and return air flow in an unconstrained environment, includes: creating a conditioned air circuit using a heat pump subsystem of the system; and creating an air curtain air circuit that isolates the conditioned air circuit from an environment that is external to the system using an air curtain subsystem of the system.

In some embodiments, conditioned air flowing through the conditioned air circuit created by the heat pump subsystem is internally recirculated and protected from mixing with ambient air by the air curtain air circuit created by the air curtain subsystem.

In some embodiments, the method also includes rejecting air from the heat pump subsystem to the environment external to the system and/or to drawing air from the environment into the heat pump subsystem to be conditioned using an ambient air intake/discharge subsystem of the system.

In some embodiments, the method also includes powering the system with a power/energy subsystem comprising one or more photovoltaic power or energy storage components for supplying power to the system.

In some embodiments, the heat pump subsystem comprises a thermoelectric cooler.

In some embodiments, the air curtain air circuit comprises a recirculation cell which is axis-symmetric about the axis of revolution.

In some embodiments, the air curtain air circuit comprises a recirculation cell is symmetric about the mirror line of the system.

In some embodiments, one or more of the heat pump subsystem and the air curtain air circuit comprises at least one fan. In some embodiments, the at least one fan comprises an impeller and/or fans in specific directions.

In some embodiments, the heat pump subsystem comprises a hybrid system with an evaporative cooler and a thermoelectric cooler.

In some embodiments, a system for actively conditioning a large space, includes: a heat pump subsystem comprising a thermoelectric unit; and an apparatus to remove the heat from the large space using the heat pump subsystem.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIGS. 1A-1D illustrate examples of outdoor climate control applications;

FIGS. 2A and 2B illustrate a psychometric chart indicating an arbitrary limit of dew point temperature (21 Deg. C), above which active cooling is needed to provide comfort conditions and traditional methods with human comfort;

FIGS. 3A-3D illustrate examples of recirculation flow structures that can be used in the system in accordance with some embodiments of the present disclosure;

FIG. 4 is an illustration of three modes of operation in accordance with at least some aspects of the embodiments described herein; and

FIG. 5 illustrates one example of a system for fluid-dynamic isolation of actively conditioned and return air flow in unconstrained environments, in accordance with at least some aspects of the embodiments described herein.

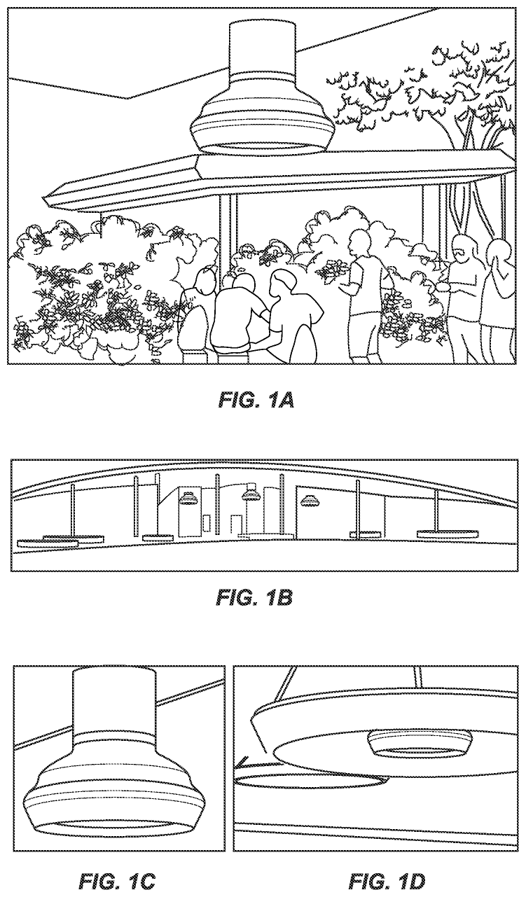

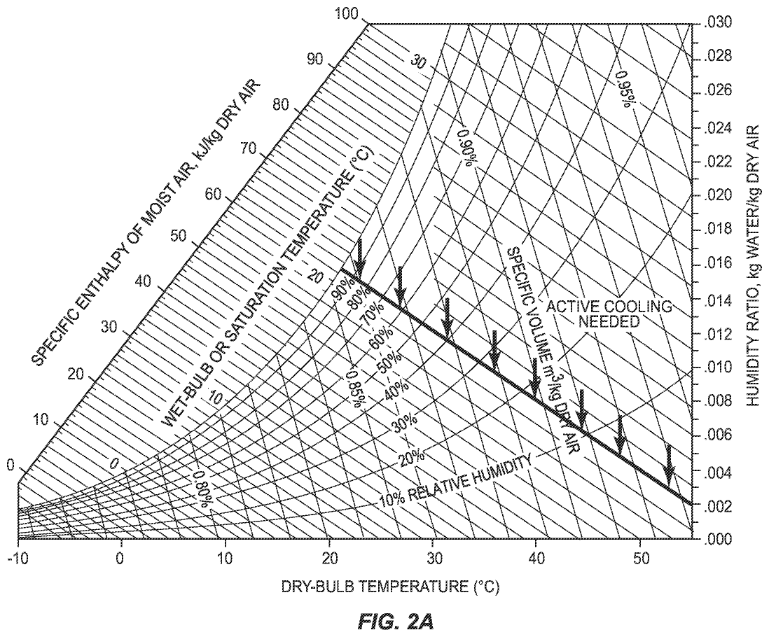

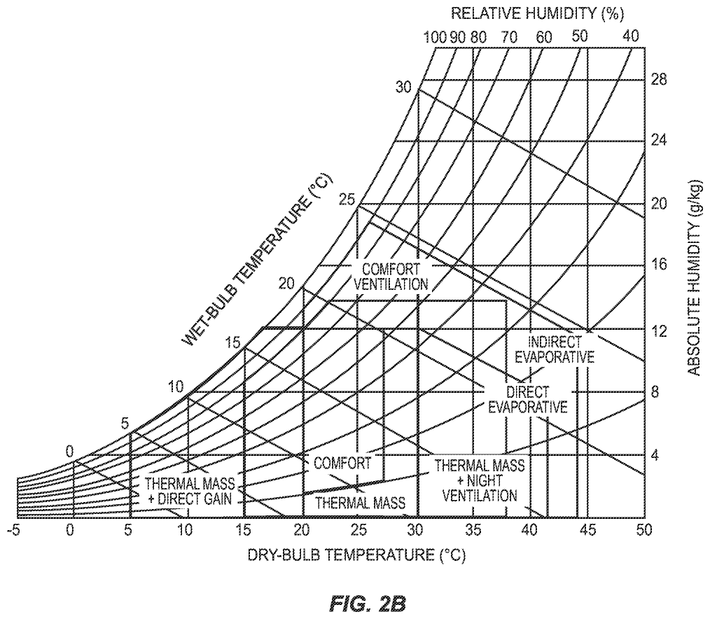

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying example embodiments.

It should be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It should also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It should be understood that, although the terms “upper,” “lower,” “bottom,” “intermediate,” “middle,” “top,” and the like may be used herein to describe various elements, these elements should not be limited by these terms. These terms are only used to distinguish one element from another. For example, a first element could be termed an “upper” element and, similarly, a second element could be termed an “upper” element depending on the relative orientations of these elements, without departing from the scope of the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having meanings that are consistent with their meanings in the context of this specification and the relevant art and will not be interpreted in an idealized or overly formal sense unless expressly so defined herein.

Systems and methods are disclosed herein for fluid-dynamic isolation of actively conditioned and return air flow in unconstrained environments. The system can be decoupled into two independent systems, namely: (1) a recirculation cell and (2) a heat pump. In some embodiments, an unconstrained environment is an area where more than one side is open to an ambient environment. In some embodiments, this might include more than one plane even including a 360 degree opening.

### Recirculation Cell

Regarding the recirculation cell, optimization of the recirculation cell requires the balancing of several competing factors. The temperature difference, ΔT=|T_{ambient}−T_{conditioned}|, and coverage area should be maximized while minimizing the total heat load to maintain those conditions. The recirculation cell preferably has calm regions to provide insulating properties while at the same time is stable for variable wind loads and reforms quickly after larger wind loads.

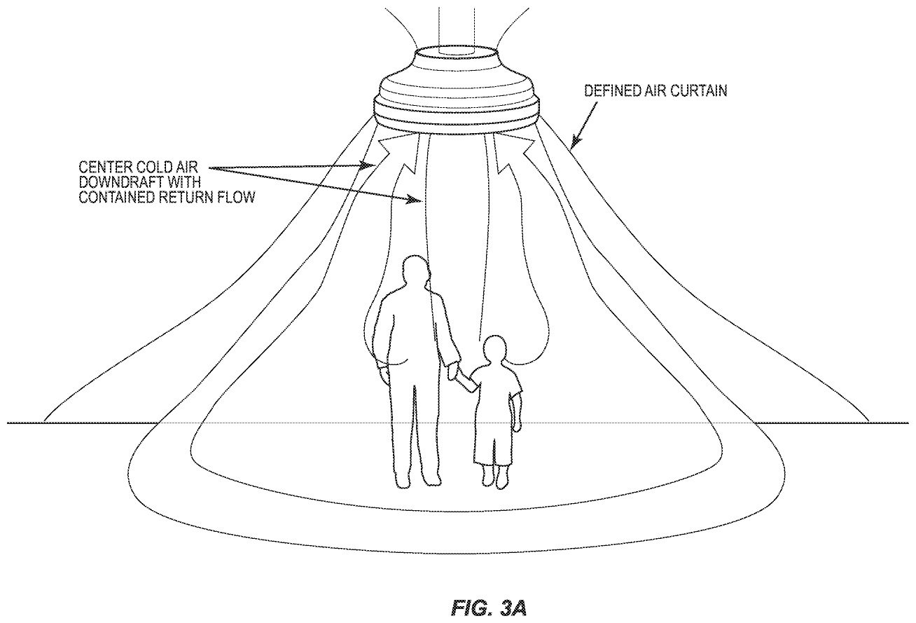

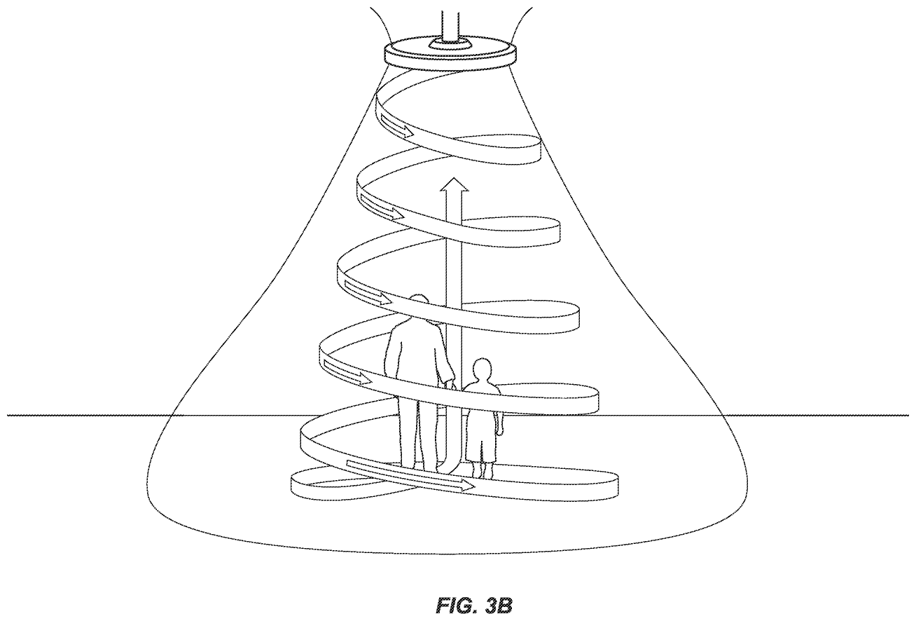

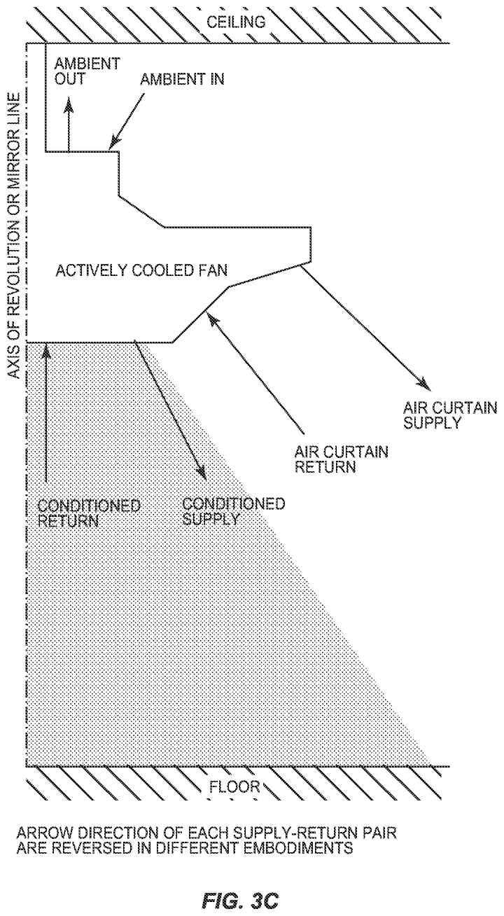

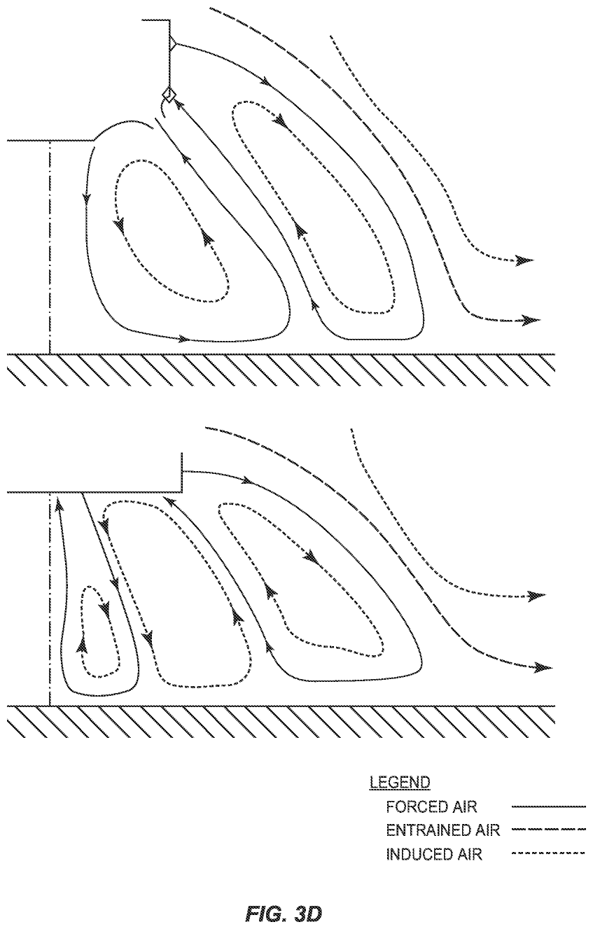

FIGS. 3A-3D illustrate examples of recirculation flow structures that can be used in the system in accordance with some embodiments of the present disclosure. These recirculation flow structures have substantial symmetry such that they can be approximated as two-dimensional flow. In one embodiment, the recirculation cell is axis-symmetric about the axis of revolution. In another embodiment, the recirculation cell is symmetric about the mirror line and the structure is projected to make a long walking path.

FIG. 3D illustrates two different flow patterns that could be generated. The first could be an example of a single-lane walk while the second could be an example of a double-lane walkway. The forced air creates an induced air current.

In general, the system (i.e., the recirculation flow structure) creates three air circuits:
1. a conditioned air circuit which provides the controlled temperature and humidity of filtered (optional) air,
2. an ambient air circuit which allows thermal communication with the ambient thermal reservoir, and
3. an air curtain air circuit that isolates the conditioned air circuit from the ambient for higher performance.
   The conditioned air circuit is nested inside an air curtain circuit. This provides significant moment to the system to contain and redirect the “conditioned supply” air back to the “conditioned return”.

### Heat Pump

Any active cooling technology can be implemented with the recirculation zone. This includes but is not limited to: solid-state (thermoelectric, magneto-caloric, elasto-caloric, electro-caloric), evaporative, adsorption/absorption, vapor compression, Stirling, and thermo-acoustic technology. A thermoelectric system is well suited for integration into a fan for micro-climate control. In some embodiments, the fan can be an impeller and/or fans in specific directions. Some advantages include the small form factor, long life, environmental friendliness and the ability to do both heating and cooling. The system will have a separate heat exchanger for the hot and cold side of the thermoelectric. Air flow for each heat exchanger will come from the space being conditioned. The output of the system will be conditioned air directed towards the space, and the ambient air circuit directed away from the space.

In some embodiments, the thermoelectric system includes features disclosed in “Thermoelectric refrigeration system control scheme for high efficiency performance” issued as U.S. Pat. No. 10,012,417, the disclosure of which is hereby incorporated herein by reference in its entirety. Additionally, any of the units from “Thermoelectric heat exchanger component including protective heat spreading lid and optimal thermal interface resistance” issued as U.S. Pat. No. 8,893,513, the disclosure of which is hereby incorporated herein by reference in its entirety. The thermoelectric system might also include any features from “Thermoelectric heat pump with a surround and spacer (SAS) structure” issued as U.S. Pat. No. 9,144,180.

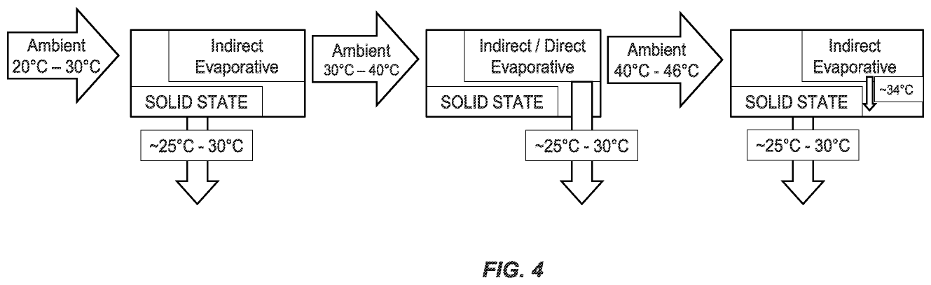

Hybridization (one embodiment: Evaporative cooler+Thermoelectric): The system could also potentially accommodate combinations of active cooling technologies. One embodiment is the use of solid state and Evaporative cooling. In this embodiment, an indirect evaporative cooler maintains a stream of HTF (heat transfer fluid (air, water, or other)) at or near the dew point. While the solid-state (thermoelectric) system can provide additional temperature drop and dehumidification or direct cooling in high humidity conditions. FIG. 4 is an illustration of three modes of operation. These three modes can be described as:
Solid-State
   a provides the primary cooling/heating at ambient temperatures between 20° C. and 30° C.
   a DTs are smallest
   a solid-state system is most efficient
Evaporative system:
   a provides the primary cooling at ambient temperatures between 30° C. and 40° C. and lower relative humidity levels
   When relative humidity is lowest an evaporative system is most effective
Hybrid:
   At ambient temperatures above 40° C. and high relative humidity, the OACIS and evaporative systems work together to provide cooling

### PV Integrated Off-Grid

In some embodiments, the system includes an integrated PV (photovoltaic) system(s). Such integration with outdoor active cooling offer several synergistic advantages:
Shade: PV provides both shade and power simultaneously
Off-grid: PV output power and thermal cooling demand scale with incident solar radiation such that the highest thermal load occurs at the same time as the highest output power. This simplifies the sizing problem such that there is little to no make-up grid power required for cooling. This minimizes or possibly eliminates the cost of electric batteries or grid tie-in equipment such as inverters.
Direct DC: a PV system produces DC circuit, which can be used directly with thermoelectrics and DC fans which saves cost associated costs of an inverter.

### System Block Diagram and Additional Information

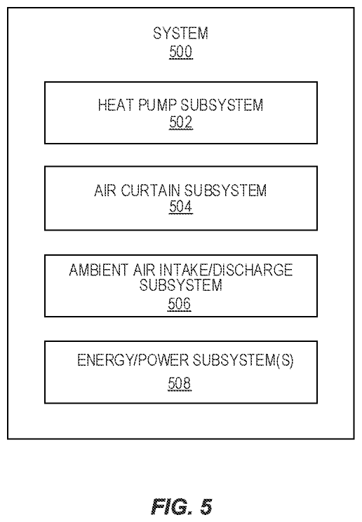

FIG. 5 illustrates one example of a system 500 for fluid-dynamic isolation of actively conditioned and return air flow in unconstrained environments, in accordance with at least some aspects of the embodiments described herein. As illustrated, the system 500 includes the following subsystems.
Heat Pump Subsystem 502: The heat pump system 502 (e.g., an active cooling system) creates the conditioned air circuit (see, e.g., FIG. 3). As described herein, the heat pump subsystem 502 includes any type of heat pump(s) or any combination of two or more types of heat pumps. The heat pump subsystem 502 may include, e.g., one or more active heat pumps (e.g., one or more thermoelectric cooling modules), heat exchanges, heat transport components, or the like, etc.
Air Curtain Subsystem 504: The air curtain subsystem 504 creates the “air curtain” air circuit. The air curtain subsystem 504 includes: an intake(s) (also referred to herein as “return(s)”), a discharge port(s) (also referred to herein as “supply(ies)”, and a fan/blower that draws in air from the ambient through the intake(s) and discharges a stream of air out from the discharge port(s) such that this stream of air is recirculated through the intake(s) to thereby create an “air curtain” (i.e., the air curtain air circuit) that isolates the conditioned air from the ambient. Note that line(s) for the conditioned air circuit, created by the heat pump subsystem 502, are internally recirculated and protected from mixing with the outside (ambient) air by the air curtain subsystem.
Ambient Air Intake/Discharge Subsystem 506: The ambient air intake/discharge subsystem 506 creates the ambient air circuit. The ambient air intake/discharge subsystem 506 includes an intake(s) and a discharge port(s). Hot air rejected by the heat pump subsystem 502 is rejected to the ambient through the discharge port(s) of the ambient air intake/discharge subsystem 506. Ambient air may be drawn into the heat pump subsystem 502 through the intake(s).
Power/Energy Storage Subsystem(s) 508 (Optional): Optionally, the system 500 includes one or more power or energy storage subsystems 508 used, e.g., to power the system 500. In addition or alternatively, the system 500 may be connected to the power grid or some other power source.

Embodiments disclosed herein provide a controlled micro-climate with active cooling/heating to provide controlled temperature, controlled humidity, and filtered air.

In some embodiments, the system disclosed herein will integrate with some form of radiative heat transfer control such as a canopy providing shade.

Table 1 below defines a few terms used herein.

TABLE 1
Term Definitions

| TERM | DEFINITION |
|---|---|
| Split system | One or more heat pump components is |
| | separated some distance by the fan. A |
| | heat transfer fluid (water, air, refrigerant, |
| | etc.) is used transfer heat |
| Heat pump | Thermodynamic work is applied to the |
| | system to pump heat from cold reservoir |
| | to hot reservoir |

Table 2 below describes some example embodiments for each subsystem. These embodiments are independent of each other, but may be utilized together in any desired combination.

TABLE 2
Example Embodiments

| Subsystem | embodiments |
|---|---|
| Recirculation cell | |
| Conditioned air circuit | Center return (outer supply) |
| | Center supply (outer return) |
| Air curtain | Supply inside, return outside |
| | Supply outside, return inside |
| | None |
| | Adapted 3D flow geometry for |
| | “stationary flow containment . . .” |
| Stationary flow | Wall(s), fence |
| containment features | Blides, screen, window |
| | Soil and landscaping |
| | Foliage (shrubs, trees, etc.) |
| Ambient air circuit | Ambient “in” and “out” located direct |
| | adjacent to fan unit |
| | One or more of ambient “in” and “out” |
| | ducted some distance from fan unit |
| | located some distance away via a |
| | “split system” |
| Heat pump | |
| type | Any |
| | Thermoelectric |
| | Vapor compression |
| | Evaporative |
| | Stirling/Thermoacoustic |
| | Magneto caloric |
| | Electro caloric |
| | Adsorption/Absorption (Desiccant) |
| | Dehumidification only |
| | Hybrid of any |
| location | Suspended from architectural |
| | structure (ceiling, armature, beam, |
| | etc.) |
| | Split system |
| Energy storage | Thermal energy storage |
| | Electrical energy storage |
| Canopy with integrated | Contains solar to electrical power |
| solar power | conversion device |
| | Contains photovoltaics |
| | Powers the system during the day |
| | Completely off-grid capable |

Those skilled in the art will recognize improvements and modifications to the preferred embodiments of the present disclosure. All such improvements and modifications are considered within the scope of the concepts disclosed herein and the example embodiments that follow.

1. A system for fluid-dynamic isolation of actively conditioned and return air flow in an unconstrained environment, comprising:
a heat pump subsystem configured to create a conditioned air circuit; and
an air curtain subsystem configured to create an air curtain air circuit that isolates the conditioned air circuit from an environment that is external to the system.

2. The system of claim 1 wherein conditioned air flowing through the conditioned air circuit created by the heat pump subsystem is internally recirculated and protected from mixing with ambient air by the air curtain air circuit created by the air curtain subsystem.

3. The system of claim 2 further comprising:
an ambient air intake/discharge subsystem configured to reject air from the heat pump subsystem to the environment external to the system and/or to draw air from the environment into the heat pump subsystem to be conditioned.

4. The system of claim 3 further comprising:
a power/energy subsystem comprising one or more photovoltaic power or energy storage components for supplying power to the system.

5. The system of claim 4 wherein the heat pump subsystem comprises a thermoelectric cooler.

6. The system of claim 5 wherein the air curtain air circuit comprises a recirculation cell which is axis-symmetric about the axis of revolution.

7. The system of claim 5 wherein the air curtain air circuit comprises recirculation cell is symmetric about the mirror line of the system.

8. The system of claim 7 wherein one or more of the heat pump subsystem and the air curtain air circuit comprises at least one fan.

9. The system of claim 8 wherein the at least one fan comprises an impeller and/or fans in specific directions.

10. The system of claim 9 wherein the heat pump subsystem comprises a hybrid system with an evaporative cooler and a thermoelectric cooler.

11. A method of operating a system for fluid-dynamic isolation of actively conditioned and return air flow in an unconstrained environment, comprising:
creating a conditioned air circuit using a heat pump subsystem of the system; and
creating an air curtain air circuit that isolates the conditioned air circuit from an environment that is external to the system using an air curtain subsystem of the system.

12. The method of claim 11 wherein conditioned air flowing through the conditioned air circuit created by the heat pump subsystem is internally recirculated and protected from mixing with ambient air by the air curtain air circuit created by the air curtain subsystem.

13. The method of claim 12 further comprising:
rejecting air from the heat pump subsystem to the environment external to the system and/or to drawing air from the environment into the heat pump subsystem to be conditioned using an ambient air intake/discharge subsystem of the system.

14. The method of claim 13 further comprising:
powering the system with a power/energy subsystem comprising one or more photovoltaic power or energy storage components for supplying power to the system.

15. The method of claim 14 wherein the heat pump subsystem comprises a thermoelectric cooler.

16. The method of claim 15 wherein the air curtain air circuit comprises a recirculation cell which is axis-symmetric about the axis of revolution.

17. The method of claim 15 wherein the air curtain air circuit comprises a recirculation cell is symmetric about the mirror line of the system.

18. The method of claim 17 wherein one or more of the heat pump subsystem and the air curtain air circuit comprises at least one fan.

19. The method of claim 18 wherein the at least one fan comprises an impeller and/or fans in specific directions.

20. The method of claim 19 wherein the heat pump subsystem comprises a hybrid system with an evaporative cooler and a thermoelectric cooler.

21. A system for actively conditioning a large space, comprising:
a heat pump subsystem comprising a thermoelectric unit; and
an apparatus to remove the heat from the large space using the heat pump subsystem.
